(19) United States
(12) Patent Application Publication
(10) Pub. No.: US 2009/0211201 A1
(43) Pub. Date: Aug. 27, 2009

(54) Apparatus and method for printing packaging elements

(75) Inventor: Peter Frei, Jona (CH)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Glaxo Group Limited, Middlesex (GB)

(21) Appl. No.: 11/918,918

(22) PCT Filed: Apr. 21, 2006
(86) PCT No.: PCT/EP2006/061744

§ 371 Date: Feb. 20, 2009

(30) Foreign Application Priority Data
Apr. 21, 2005 (EP) 05405309.5

(51) Int. Cl. B65B 61/02; B41J 3/28

(52) U.S. Cl. 53/411; 53/131.2; 53/131.4

(57) ABSTRACT

An apparatus for printing isolated packaging elements (11) comprises a conveyor (10) comprising a plurality of transportation segments (15), wherein the isolated packaging elements (11) are maintained in a stock (21). A feeder (20) is provided to transfer at least one isolated packaging element (11) from the stock (21) on one transportation segment (15), wherein each isolated packaging element (11) is held fast on the corresponding transportation segment (15) through a holding element associated to said transportation segment (15). At least one drive (26) is connected with the conveyor (10) to move the conveyor (10). A print module (40) is provided above the transportation segments (15) to print, on the isolated packaging element (11), the sides (12, 13) opposite to the surface oriented towards the transportation segment (15).

### TECHNICAL FIELD OF THE INVENTION

The invention relates to an apparatus and a method for printing packaging elements, especially isolated packaging elements, and more specifically pre-folded boxes or cartons.

### PRIOR ART

Apparatuses are known from the prior art to prepare packages with information, advertisement, trademarks, content relating data, and so on. Such apparatuses have a feeder, loaded with an endless sheet of packaging material, e.g. paper, cardboard, metal or plastic, wherein said sheet of material is pushed or pulled under printing modules to cover the surface of the packaging material. Then, the package element to be generated is punched out, folded, attached or glued together and filled with the content.

Such an apparatus has the drawback not to be adapted to prepare smaller batches or series of packaging elements. This is due to the fact that quite a lot of items of the apparatus have to be adapted within the apparatus when a different package has to be provided. This relates to the width of the sheet of packaging material, the punch dies to prepare the punched-out cartons and the guides of a folding mechanism in order to prepare the folded boxes or cartons.

### SUMMARY OF THE INVENTION

It is therefore an object of the invention to provide an apparatus and method, which can be readily adapted, to prepare small batches of packaging elements.

Said object can be reached for an apparatus through the features of claim 1.

An advantageous method of preparing such package material uses e.g. ink-jet or flexo printers to print the necessary colours and information on the package element. It is complex to use a four-colour print module to print such isolated packaging materials. Therefore, according to a preferred embodiment, the conveyer is generally driven by belt or cog-wheel-engagement with segments. However, this transportation mechanism is only used for parts of the parallel transportation means called non-precision areas. Within the remaining areas, called precision areas, near the print-module, below the height-checking module and in the adjacent areas, a different, more stringent approach is taken.

### SHORT DESCRIPTION OF THE DRAWINGS

FIG. 1 shows a schematic view of the different stations and modules of an apparatus, according to the invention,

FIG. 2 shows a schematic side view of the middle part of the transportation segments under the print-module,

FIG. 3 shows a schematic front view of the one transportation segment of the apparatus according to the invention, and

FIG. 4 shows a perspective view of one transportation segment for use with the apparatus according to the invention.

### DETAILED DESCRIPTION OF AN EMBODIMENT OF THE INVENTION

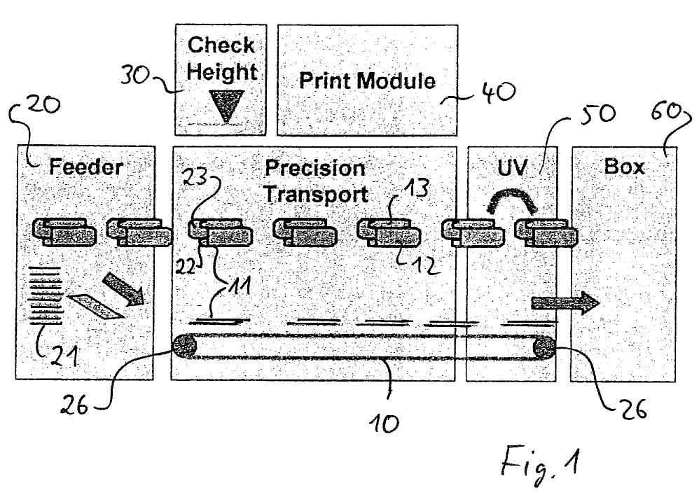

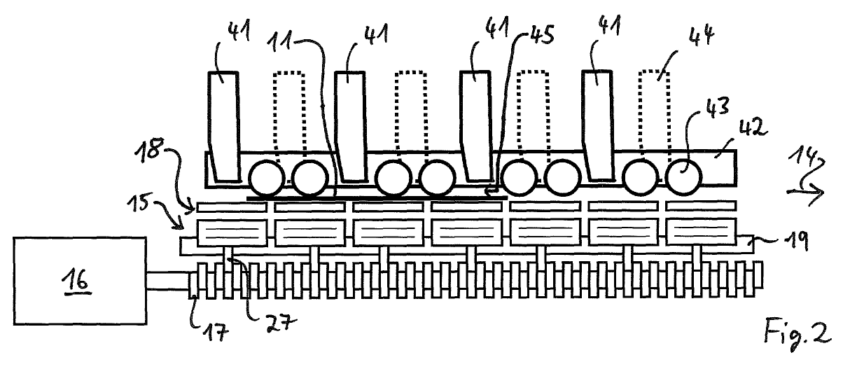

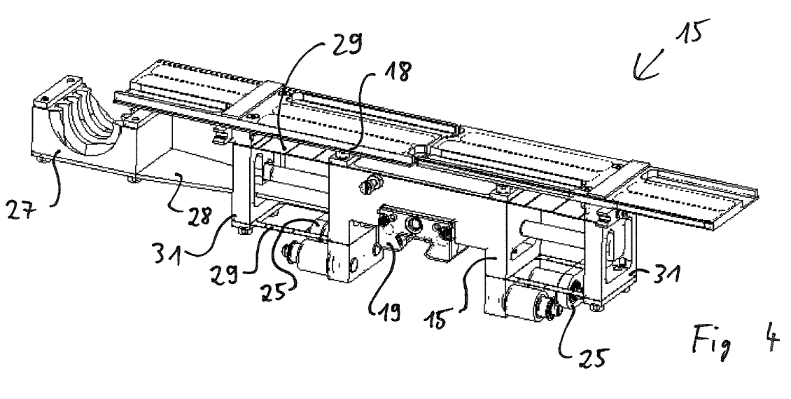

FIG. 1 shows a schematic view of the different stations of the device, according to the invention. The central part of the apparatus is the conveyer 10, being driven at both ends by conventional drives 26. Preferably the conveyor 10 comprises a plurality of transportation segments 15, wherein two adjacent segments 15 are joined together with a chain element 15. Some transportation segments 15 are shown in FIG. 2 when they are adjacent to a print module, wherein one specimen is shown in FIG. 4.

A stock 21 of packaging elements 11, together with a feeder 20, initially transfers the packaging elements 11 on said transportation segments 15. Every transportation segment 15 has one or more holding elements, e.g. clamps, to position any element 11 precisely. Preferably the transportation segment 15 has a front abutment surface to position any element correctly. However different mounting procedures can be chosen. The elements 11 are isolated packaging elements, in the shown embodiment these are pre-folded cartons 11, having an upper surface 12 and a side surface 13 to be printed on within this passage through the apparatus, according to the invention. Therefore these pre-folded cartons comprise in most parts two layers of cardboard. Within the central area between the drives 26, there exists a precision transport area, which is shown schematically in FIG. 2. This precision area comprises the height-checking station 30 and the print module station 40. The height-checking station 30 preferably has sensors, e.g. light sensors to detect any cartons, which are not held absolutely, flat. Such packaging elements 11 are pushed out of the way of movement of the conveyor 10 because the distance between the cartons 11 and the print heads 41 as can be seen in connection of FIG. 2 is very small and any physical contact between the cardboard and a print-head 41 can damage the latter. This is especially true if ink-jet print heads 41 are used.

An UV drying station 50 is provided downstream of the print module 40 to cure and dry the sprayed inks.

Finally the folded box or carton 11 is pushed outside the apparatus into a box 60. Later on, the stock 21 can either be replaced with the pre-printed box-content 60 presented upside-down, or there is provided a parallel two-lane system, wherein the half-printed elements 11 are reversed and pass another time through the transport circle and therefore the print module 40. In both alternatives the print module 40 prints within this second passage of the packaging material through the apparatus the necessary information on the outside of the surface 23 and on the other side surface 22.

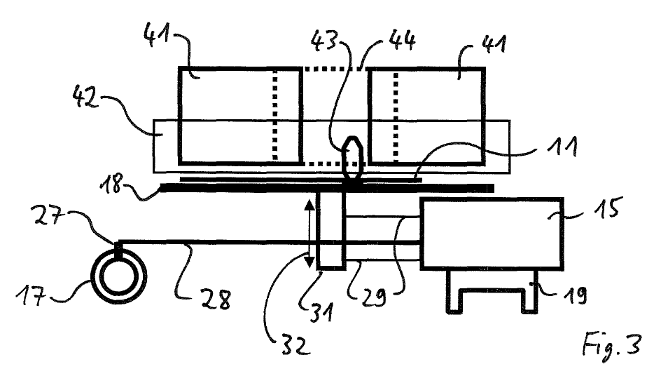

FIG. 2 shows a schematic side view of the middle part of the transportation segments 15 under the print module 15. Upstream and before the folded box 11 enters the print module 40, the placement of the packaging material 11 is checked with the help of the height-checking module 30 (not shown in FIG. 2). Already in this region there are provided wheels 43 to push the packaging material 11 on the mounting platforms 18. It will be seen in connection with FIGS. 3 and 4 that these mounting platforms 18 can react flexible in a vertical direction. Therefore the mounting platforms 18 press the cartons 11 up towards the print heads 41 onto series of reference rolls or wheels 43. These rolls 43 set the shooting distance reference to between the ink jet print heads 41 and the media, i.e. the packaging material. This ensures that no adjustments need to be made when changing between different carton types, sizes and thickness, because the distance from the uppermost carton layer, i.e. the surfaces 12 and 13, is defined through the rolls 43. Within the shown embodiment there are at any time at least two rolls 43 in contact with the carton 11 providing firm fixation to the mounting platforms 18, wherein the rolls 43 are mounted all in a row. However in other embodiments there can be provided different rows of rolls 43 with different distances between the rolls 43.

It has been noted that print heads 41 are arranged in a short vertical distance 45 from the folded box material 11, e.g. usually between 1 and 2 millimetres. The print heads 41 are each fixed on a head-mount 42. The profile of the head-mount 42 also supports a plurality of bearings, within which pairs of rolls or wheels 43 are supported. Preferably, a pair of wheels 43 is mounted before and behind every print head 41 to ensure that the distance between the bottom of each print head 41 and the packaging elements 11 to be printed is almost constant (i.e. the vertical distance 45). The dotted elements 44 show a further series of print-heads, which may be provided literally between the first-mentioned print-heads 41, to provide a wider printing area.

As can be seen in FIG. 2, there is a plurality of mounting platforms 18, as part of the transportation segments 15, wherein all mounting platforms 18 are parallel to each other and said mounting platforms 18 support the packaging elements 11. The mounting platforms 18 can touch each other. The transportation segment 15 below is gliding on a linear guide 19.

Each transportation segment 15 has an engagement structure 27, engaging the worm 17. The longitudinal axis of worm 17 is oriented in the direction 14 of movement of the transportation segments 15 and the worm 17 is provided between a pre-defined distance before the first print head 41 until a small distance behind the last print head 41 or 44. This distance is called precision transport area. Therefore, the transportation segments 15, within the range of the print module 40, are solely driven by the drive 16 via the worm 17, and there is no force-engaging relationship between the transportation segments 15 and the conveyer drive 26 mentioned above. The worm-driven section preferably also encompasses the height-checking module 30.

FIG. 3 shows a schematic side view of the transportation apparatus. The transportation segment 15 is mounted to glide on the linear guide 19. There is a connection through profile 28, ending in engagement means 27, directly engaging the worm 17. Profile 28 is rigid and ensures a smooth displacement of parallel-arranged transport segments 15 along the direction indicated by arrow 14 in FIG. 2. Each transportation segment 15 is connected with the mounting platform 18 through two parallel flat springs 29, fixed on one side on the transportation segment 15 and on the other side on a profile piece 31. Due to the parallelogram created through the connection between the profile piece 31 and the transportation segment 15 via the flat springs 29, the mounting platform 18 can be displaced vertically along the double-arrows 32 in a flexible way. This ensures that the pressure of the guiding wheels 43 is properly transmitted on the packaging element 11 and the vertical distance 45 between uppermost surface of the packaging element 11 and the lower surface of every print head 41 or 44 is maintained. It has to be noted that it is not the friction between the packaging element 11 and the mounting platform 18, which is moving the packaging element 11, but that each packaging element 11 is held fast through fixing clamps or abutment surfaces, etc. provided on the moving element

It is possible to provide an additional series of displaced second print heads 44, as usual one print-head 44 is provided for each colour, to enable a wider printing area, as necessary for the wider packaging element 11 of FIG. 3. If a multi-colour print is contemplated, than usually the print heads 44 are printing magenta, cyan, yellow and black.

It is also possible to provide a second group of print heads 41 in parallel to the existing first group of print-heads 41, enabling the printing of two packaging elements 11 in parallel on one mounting platform.

It is also possible to provide another profile bar 28 on the other side of the transportation segment 15, engaging via additional engaging means 27 a second worm 17, mounted in parallel to the first worm 17 on the other side of the transport segments 15.

FIG. 4 shows a perspective view of the transportation segment 15, provided on the linear guide 19. The upper flat spring 29 is a leaf, whereas the lower flat spring 29 is a pair of parallel spring webs. The profile bars 28 form the basis for a half-cylindrical piece 27, which is attached to the profile bar 28 and has a complementary threaded form to the driving-worm 17. The mounting platform 18 comprises a structure of different flat pieces, enabling a front abutment surface for the packaging elements 11, as well as mounting platforms for clamps (not shown), holding said packaging elements 11 on the mounting platform 18. The choice of the clamps depends on the cartons, boxes or packaging materials 11 to be held.

Reference number 25 designates chain links on both sides of the U-shaped profile of a transportation segment 15, connecting two adjacent transportation segments 15. Although there is such a connection between all transportation segments 15 forming a continuous band as can be seen in FIG. 1, there is no force transmission via the conveyor 10 from the drives 26 in the area of the print-modules. This is important to ensure that the advance of the packaging material 11 is completely continuous which is necessary to obtain the best printing results. The section wherein each segment is driven and positioned individually like in a tooling machine, is called precision transport section and is located adjacent and under the print heads. Outside of said precision area (not shown in FIG. 2), segments 15 are pulling each other similar to standard segment belt applications and are driven by one or two belts drives 26.

It is contemplated that the packaging element can be composed of different materials. A pre-folded and glued box or carton which has only to be de-folded to create an parallelepiped is one choice for a packaging material 11, which can be individually printed on all outer surfaces, if the packaging material 11 is guided twice through the apparatus, either the same print lane or a parallel one, depending on the re-feeder mechanism. The surface to be printed upon can be in different materials as aluminium, laminated paper, plastic material, PET or polypropylene, wherein appropriate inks or print heads are chosen by someone skilled in the art.

### REFERENCE NUMERALS

10 conveyor
11 isolated packaging element
12 upper surface of the carton
13 side surface of the carton
14 direction of conveyor movement
15 transportation segment
16 drive
17 worm
18 mounting platform
19 linear guide
20 feeder
21 stock
22 upper surface of the box
23 side surface of the box
26 drive
27 engagement means
28 profile
29 flat spring
30 height checking module
31 profile
32 double arrow
40 print module
41 print head
42 print head mount
43 wheel
44 print head
45 short vertical distance
50 UV drying module
60 box

1-9. (canceled)

10. An apparatus for printing isolated packaging elements, comprising:
a conveyor comprising a plurality of transportation segments and a precision motion section;
a stock for stocking isolated packaging elements;
holding elements each associated to a corresponding transportation segment;
a feeder to transfer at least one isolated packaging element from the stock on one of the transportation segments;
one drive connected with the conveyor at one longitudinal end of the conveyor to move the conveyor;
a worm being direct engagement with the plurality of transportation segment in said precision motion section;
an additional drive to drive the worm; and
a print module provided above the plurality of transportation segments in the vicinity of the precision motion section to print, on the isolated packaging element, the sides opposite to the surface oriented towards the transportation segment;
wherein each isolated packaging element is held fast on the corresponding transportation segment through one holding element associated to said transportation segment;
wherein said one drive is supporting the movement of the transportation segment outside the precision motion section.

11. The apparatus according to claim 10, wherein the module comprises four print heads in a row to prepare multi-color prints on the packaging elements.

12. The apparatus according to claim 10, wherein one drive is provided at each longitudinal end of the conveyor.

13. The apparatus according to claim 10, wherein a plurality of rolls is provided near the print heads of the print module extending a predefined distance below the bottom surface of the print heads to define a vertical guiding distance between said print heads and the uppermost surface of packaging elements.

14. The apparatus according to claim 13, wherein each transportation segment comprises at least one mounting platform flexibly connected to the corresponding transportation segment to push guided packaging elements from below against the rolls.

15. The apparatus according to claim 14, wherein the mounting platform is connected with the correspond g transportation segment through a spring parallelogram.

16. An apparatus for printing isolated packaging elements comprising:
a conveyor comprising a plurality of transportation segments and a precision motion section;
a stock for stocking isolated packaging elements;
holding elements each associated to a corresponding transportation segment;
a feeder to transfer at least one isolated packaging element from the stock on one of the transportation segments;
at least one drive connected with the conveyor to move the conveyor;
a print module comprising at least one print head; and
a plurality of rolls provided near the at least one print head wherein the module is provided above the transportation segments the in the vicinity of the precision motion section to print, on the isolated packaging element, the sides opposite the surface oriented towards the transportation segment, wherein each isolated packaging element is held fast on the corresponding transportation segment through one holding element associated to said transportation segment, wherein the rolls are extending a predefined distance below the bottom surface of the at least one print head to define a vertical guiding distance between said at least one print head and the uppermost surface of the packaging elements.

17. An apparatus according to claim 16, wherein each transportation segment comprises at least one mounting platform flexibly connected to the corresponding transportation segment to push guided packaging elements from below against the rolls.

18. An apparatus according to claim 17, wherein the mounting platform is connected with the corresponding transportation segment through a spring parallelogram.

19. An apparatus according to claim 16, wherein said drive provided at the longitudinal end of the conveyor is supporting the movement of the transportation segments outside the precision motion section, and in that at least one additional drive is driving a worm being in direct engagement with every transportation segment in said precision motion section, especially being in reach of the print module.

20. A method for printing isolated packaging elements, comprising the steps of:
providing a stock of isolated packaging elements;
transferring at least one isolated packaging element from the stock with a feeder on one transportation segment of a conveyor;
holding each isolated packaging element on the corresponding transportation segment through a holding element associated to said transportation segment;
driving the transportation segments with at least one drive; and
printing the upper surfaces of the isolated packaging elements opposite to the surface oriented towards the transportation segment using a print module provided above the transportation segments.

21. The method according to claim 20, wherein said drive drives the conveyor outside a predefined precision movement section, whereby adjacent transportation segments are connected together, and wherein the transportation segments are driven within the predefined precision movement section through direct engagement of a threaded part with a worm.
